(19) United States
(12) Patent Application Publication
(10) Pub. No.: US 2009/0294523 A1
(43) Pub. Date: Dec. 3, 2009

(54) Method, System and Device for Identification from Multiple Data Inputs

(76) Inventors: Robert F. Marano, Cedarhurst, NY (US); Lawrence Hausman, Selden, NY (US); Simon Ben-Avi, New York, NY (US)

Correspondence Address: Pearl Cohen Zedek Latzer, LLP, 1500 Broadway, 12th Floor, New York, NY, 10036, US

(21) Appl. No.: 11/794,621

(22) PCT Filed: Jan. 3, 2006
(86) PCT No.: PCT/US2006/000061

§ 371 Date: Jul. 2, 2009

Related U.S. Application Data
(60) Provisional application No. 60/640,258, filed on Jan. 3, 2005.
(60) Provisional application No. 60/685,540, filed on May 31, 2005.
(60) Provisional application No. 60/729,197, filed on Oct. 24, 2005.

(51) Int. Cl. G06K 5/00

(52) U.S. Cl. 235/380

(57) ABSTRACT

A device, system and method including a mobile unit having a location sensor to detect location data of a unit; a biometric sensor to detect a biometric property of user of the unit; a display to prompt the user of the unit to input personalized data into for example an input interface; a memory to store identification data; a user input interface to receive identification data; a transmitter to wirelessly transmit location data, biometric data, personalized input and identification data; and a mobile power source to power the unit.

### PRIOR APPLICATION DATA

This application claims the benefit of prior U.S. provisional patent applications (a) 60/640,258 filed Jan. 3, 2005 and entitled Method and Apparatus for Deriving an Electronic Key from Multiple Data Inputs, (b) 60/685,540 filed May 31, 2005, and (c) 60/729,197 filed Oct. 24, 2005, each of which is incorporated in its entirety by reference herein.

### BACKGROUND OF THE INVENTION

Electronic Identification Systems (EIDS) may control access to data, transaction authority, physical locations and to information while enabling secure, accurate commercial transactions, over a network, in person or otherwise. EIDS use codes in place of conventional hardware locks and keys.

Devices known in the art using EIDS use a single or multiple set of personal identifiers (PI) to request access and upon which to base an authorization of identification. In such configurations, although security is provided, compromise of the single PI will compromise the controlled access.

### SUMMARY OF THE INVENTION

Embodiments of a method of the invention include requesting a verification of a transaction; receiving at a portable device a request for data input, where such data input may include biometric data of a user, a geospatial position of a device, a query posed to a user using a device, and an identification data from a memory associated with a device; obtaining responses to the request for data input; and transmitting a responses to the requests for data input.

Embodiments of another method of the invention may include receiving at a central device a request for a transaction verification; receiving from a portable device biometric data of a user, a geospatial position of the portable device, and at least one element of identification data; processing the received biometric data, the received geospatial position, and the received identification data to determine whether the transaction verification should be provided; and transmitting a result of the processing to a merchant device.

A device in accordance with an embodiment of the invention that includes a mobile unit having a location sensor to detect location data of unit; a biometric sensor to detect a biometric property of a user of the unit; a display to prompt the user of the unit to input personalized data into for example an input interface; a memory to store identification data; a user input interface to receive the personalized data; a transmitter to wirelessly transmit location data, biometiic data, personalized input and identification data; and a mobile power source to power the unit.

A system in accordance with an embodiment of the invention may include a first unit including for example a user input interface, a biometric sensor, a location sensor, a memory, a display and a transmitter to transmit data from for example one or more of the interface, the biometric sensor, the location sensor and the memory; and a second unit that may include a receiver to receive data from the first unit, a processor to process the received data and further to determine whether the contemplated transaction should be verified, and a transmitter to transmit the determination; and a third unit that may include a transmitter to transmit to the second unit a request for verification and a receiver to receive from the second unit the determination.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIGS. 1A and 1B are simplified block diagrams of a front view and back view of a device that may collect multiple data inputs for an identification process according to embodiments of the present invention;

FIG. 2 is a simplified diagram of a system that may collect identification data from two or more parties and provide identification authorization to two or more parties, in accordance with embodiments of the present invention; and

FIG. 3 is a flow diagram of a method in accordance with embodiments of the invention.

It will be appreciated that for simplicity and clarity of illustration, elements shown in the figures have not necessarily been drawn accurately or to scale. For example, the dimensions of some of the elements may be exaggerated relative to other elements for clarity or several physical components included in one functional block or element Further, where considered appropriate, reference numerals may be repeated among the figures to indicate corresponding or analogous elements. Moreover, some of the blocks depicted in the figures may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Embodiments of the invention provide a method and apparatus for combining multiple unique inputs from, for example, biometric data collection devices with, for example, PI alphanumeric code devices. For example, in some embodiments of the present invention, the implementation of the combining of the inputs may be based on digital processing. These implementations may be integrated into existing devices using firmware embedded in, for example, digital signal processing devices. Moreover, although the scope of the present invention is not limited in this respect, some embodiments of the present invention may be configured to operate within the boundaries set by standards of the Institute of Electrical and Electronics Engineers (IEEE), or any other standards body.

The invention is described below in the context of a secure EIDS. However, it will be apparent to persons skilled in the art that the invention may also be suitable for other systems or device that requires multiple PI in order to provide access to either a physical location, to data, or to a commercial or sensitive transaction involving money or credits, which may, for example, be of a sensitive or non-public nature.

An embodiment of the present invention includes an implementation of a secure EIDS, wherein an encryption algorithm circuit may combine multiple PI data items in order to create a secure key that may accurately authenticate the identity of the user that is requesting transaction access. The use of multiple PI data items may add to the security of the key, for example, because several PI data items must be available to create or re-create the key. Moreover, in some embodiments an encryption algorithm or processor to execute such algorithm may not be required at the host database.

In some embodiments, a secure key is produced or made available during the process of authentication, but information, such as, for example the biometric data of the user or the geospatial positioning coordinates may not be made available to the host database.

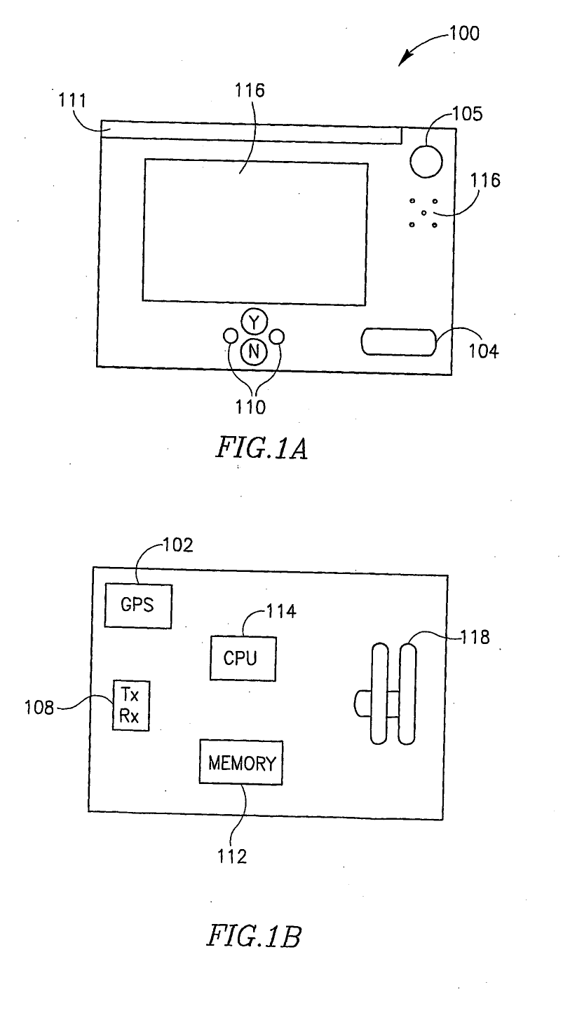

Reference is made to FIGS. 1A and 1B, a simplified block diagram of a front view and back view of a device that may collect multiple data inputs for an identification process according to an exemplary embodiment of the present invention. In some embodiments, a device 100 may be or include a device suitable for accepting multiple data inputs that may be used for identification of for example a user or other party to for example a transaction. Device 100 may be used for other purposes such as for example for providing access to data or to a restricted area. Other uses are possible.

In some embodiments, device 100 may include for example a location sensor 102 such as for example a global positioning circuit or other position sensor, at least one biometric sensor 104 such as for example a fingerprint sensor or imager 105, a display 106, such as for example a liquid crystal display, a communication transmitter/receiver 108 such as for example a wireless transmitter/receiver such as for example a cellular transmitter, Bluetooth transmitter, RF transmitter or for example a modem, an input/output user interface 110, such as for example one or more buttons, pads, keys, or touch-sensitive overlay to display, a memory 112, such as for example a non-volatile memory, a controller 114, such as for example a processor that may for example execute digital signal processing functions, encryption functions and other functions, a microphone, sound sensor and/or speaker or sound system 116, an antenna 111, and a power source 118 such as for example one or more batteries.

It will be understood that the device, system and method of the present invention may be used for any purpose where a person's identity needs to be proven, such as, for example, where requesting access to physical premises, to information or to an electronic server, or initiating a consumer transaction in person or on-line. It will be understood that where reference is made to a merchant or a transaction, these are merely anticipated uses of the invention; however, the invention should not be regarded as limited to such context

In operation, and in some embodiments, device 100 may be, include or be part of an identification system. For example, a user who may wish to execute for example an on-line transaction or access a restricted area, may transmit for example a unique number to a merchant who may be accepting the transaction or authorizing entry. In response, a merchant or some other party, may request that the user for example input biometric sensory information such as for example a fingerprint, onto the biometric sensor 104. The user may also be requested to confirm his location by way of the location sensor 102, and respond to or answer one or more questions that may be posed to him and that may appear on the display or visual indicator 106 or that are announced over sound system 116. In some embodiments, the user through device 100 may convey one or more of the location data, biometric data, response to queries or other data over a transmitter/receiver 108. The information may be transferred directly to merchant or for example to an identity authorization entity or trusted authority, which may then confirm the identity of the user and communicate this confirmed identity of the user to the merchant who may then for example authorize the transaction, grant entry or take another action on the basis of the confirmed identity.

In some embodiments, when a user may wish to execute a transaction, or otherwise gain identity authorization from another party, the user may provide the other or second party with an initial identification code or password that may be stored in for example device 100. The merchant or second party may provide this code to for example a trusted identification authority such as for example a bank or other service provider or third party. The third party may contact the user by way of the device 100 and collect multiple data inputs from the user or other data based on multiple data inputs from the user. The third party may compare the data from the user to stored data, and upon confirmation of the data, may issue a confirmation to the second party. In some embodiments, the third party may also confirm to the user the identity of the second party.

Location sensor 102 may generate or calculate a position such as a latitude and/or longitude or altitude coordinate of device 102 at particular time. In some embodiments, location sensor 102 may include a neo-positioning sensor that may calculate a position of the device 100 from for example data transmitted via radio frequency, or for example from satellite data. Other methods or circuits capable of generating location data are possible, such as for example terrestrial based systems that may transmit information that may be used for example for triangulation calculations or other such systems.

In some embodiments, device 100 may include a biometric sensor 104. Biometric sensor 104 may be or include for example a fingerprint sensor, such as for example sensor UPEK TCS3-TCD41 Touch Strip Solution sensors. Other suitable fingerprint sensors are possible. Other biometric sensors 104 may include for example an eye scanner, a scanner of portions of the eye, a blood vessel scanner, a voice scanner, or other sensors that may generate, calculate or measure unique physical characteristics of a human user. In some embodiments, device 100 may be linked by for example a wire or wireless link to for example a biometric sensor such as for example a heart beat monitor that may be worn on a user but that may be a separate unit from deice 100.

In some embodiments, transceiver (TxRx) 108 may be or include for example a circuit or series of circuits that transmit and or receive for example digital signals to, from or between device 100 and a second or third party. In some embodiments, TxRx 108 may be or include a modem such as for example a wireless modem, a Bluetooth transmitter/receiver, a cellular transmitter/receiver, a radio frequency transmitter receiver or other circuit suitable for transmitting and/or receiving data signals.

In some embodiments, display or visual indicator 106 may be or include any device for visual indication of communication, for example one or more light-emitting diodes, or a liquid crystal display (LCD) that may include for example a touch screen control function, or some other display that may be suitable for displaying characters, images or other data to for example a user. In some embodiments, display 106 may be or include a 3.5 inch 320*240 TFT True Color LCD touch screen controller such as for example those available from Sharp as model number LQ038Q5DR01. The display may be or include for example one or more light emitting diodes or other visual communication device. Other displays are possible.

In some embodiments, user interface 110 may be or include one or more keys, pads, buttons or other suitable input devices by which for example a user may input data or responses to device 100. Other data input devices such as for example a touch screen are possible.

In some embodiments, memory 117 may be or include one or more of a random access memory, read only memory, non-volatile memory such as for example a flash memory, a magnetic disc drive or other data storage device that may store and/or recall data that may be input or transmitted to device 100.

In some embodiments, processor 114 may be or include a processor or controller that may be for example included on a semi-conductor device. Processor 114 may in some embodiments include or be suitable for digital signal processing. In some embodiments, a processor such as those available from Analog Devices, such as for example BF566 or BF563 may be included in device 100. In some embodiments, processor 114 or another circuit that may be attached to processor 114 or otherwise included in device 100, may include or be suitable for encryption or de-encryption of data such as for example data supplied by one or more of location sensor 102, biometric sensor 104, user interface 110 or other data. In some embodiments, processor 114 or another component, may generate or calculate or use in calculations, an existing, for example an electronic key based on some or all of the multiple data inputs of device 100.

In some embodiments, power source 118 may be or include one or more batteries, such as for example rechargeable batteries, lithium batteries, fuel cell, or other portable power sources as may be suitable for operation of an electronic device such as device 100.

In some embodiments, sound system 116 may include one or more of a microphone and speaker, such as for example a microphone and speaker that may be suitable for conveying or collecting voice signals, data signals such as those transmitted by a modem, and other audible signals.

In some embodiments, device 100 may be or include a portable card-shaped device that may be carried by a user in for example a wallet, purse or other worn items. Dimension of a device 100 may be approximately 3.6 inches in length, 2.6 inches in height and approximately 0.25 inches thick. Other shapes may be used. In some embodiments, device 100 may be or include an attachment to or part of for example a cellular hand set, personal digital assistant, messaging device such as for example a pager, email reader or other for example, hand-held device.

In some embodiments, device 100 may include one or more instructions such as for example electronic or software instructions that may execute commands provided to or from device 100.

It will be understood that the device of the present invention may be used to provide authentication directly to the merchant, or authentication may be made through a trusted third party, such as a service provider. Below is described an example of a third party authentication provider; however, it will be recognized that many configurations or sequences are possible in connection. with the device, system and method of the present invention.

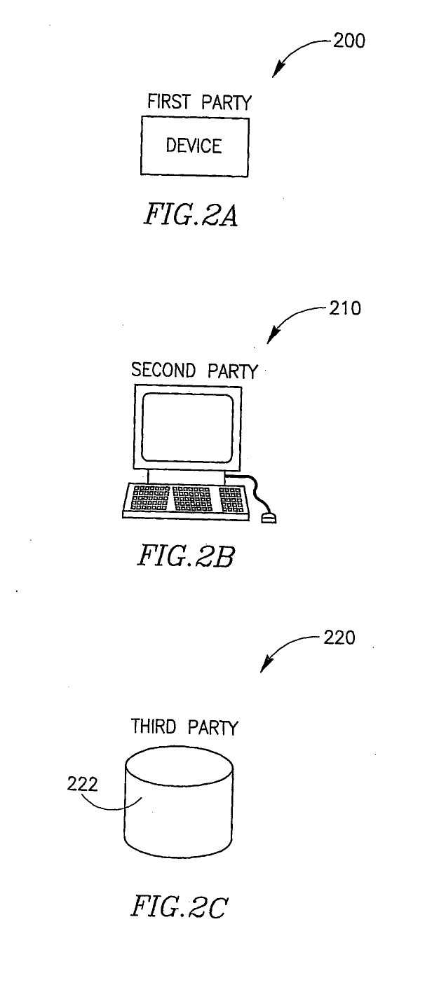

Reference is made to FIG. 2, a simplified diagram of a system that may collect identification data from two parties and provide identification authorization, in accordance with embodiments of the present invention. In some embodiments, a first party such as for example a user, consumer or party to a transaction may contact for example a second party to for example initiate a transaction. In some embodiments, a user may provide for example an initial identification number to the second party or merchant either manually or automatically via the device of the present invention. The initial identification number may be generated by or stored in for example device 200 that may for example be in the possession of user. Device 200 may be any suitable two-way communication device, such as, for example, the device shown in FIG. 1 or variations thereof Device 200 may include or use some or all of the sub-systems or sub-units described above in connection with FIG. 1. In some embodiments, initial identification number may be a variable, unique or time dependent number that may be generated by device 200 in respect of the particular transaction requested by for example a user. Other methods or processes for generating an initial identification number may be used. In some embodiments, no initial identification number or no initial identification process may be used. Other numbers of parties are possible, and the identity of other number of parties may be confirmed.

In some embodiments, a second party 210, such as for example a merchant or other provider or goods, services or access, may contact third party trusted authority 220 such as for example a security service provider, authorization confirmation services provider or other trusted authority, and the second party may provide to the third party for example the initial identification number or other authorization initiation data, that may indicate that the user desires to initiate an identification authorization process, and other information on the user's request, for example, the value or type of transaction requested.

In some embodiments, the third party may confirm the identity of the second party using an interactive configurable process, involving for example input from device 200. In some embodiments, device 200 may be or be included in a computing device such as for example a work station, personal computer, point of sale terminal or other electronic device. In some embodiments device 200 may be a portable multi input data device similar to device 100. Depending on the capabilities of the user device 200 and the merchant device 210, third party 220 may collect from the second party 210 and/or from the user 200 multiple data inputs such as location data, biometric data of a second party representative, responses to queries, other data and/or encrypted data or electronic keys that may be based on or include such data. The data transmitted by second party 210 may in some embodiments be compared to data stored by third party in a data storage facility 222, or may be otherwise processed by a processor (not shown), and third party 220 may confirm the identity of second party 200 and the authorization of second party 200 to proceed in a transaction with a user of device 200.

In some embodiments, third party may transmit or otherwise issue to a user of device 100, a confirmation of the identity of second party 200, and second party's authorization to proceed with a transaction with user. In some embodiments, no such confirmation to a user may be provided.

Third party trusted authority 220 may contact user's device 200 and request that the user or device 200 provide multiple data inputs such as for example location data, biometric data, responses to queries and other data. The multiple data inputs may be encrypted or used in the generation of an electronic key, and may be transmitted for example wirelessly to for example third party 220. Third party 220 may receive data from the user of device 200 and may compare the received data to data stored in for example storage facility 222. Upon satisfaction, third party 220 may confirm the identity of the user and may generate and transmit a confirmation to second party 200. In some embodiments, such confirmation may include for example a particular time during which the second party 200 may rely upon the confirmation, a particular transaction for which the confirmation is valid and other data. In some embodiments, a confirmation may be supplied to one or both of the user by way of for example device 100 or otherwise, and to the second party, and may indicate that the identity of both parties was confirmed. Other data may be included in a confirmation, and a confirmation may be provided to other parties.

According to embodiments of the present invention, the user of device 200 may have a profile stored at third party 220, for example, in facility 222. The profile may in advance of the transaction be configured according to the needs of the particular user. Thus, for example, a user may pre-configure a profile to exclude certain transactions, based, for example, on type of transaction and/or value of transaction. Thus, for example, a user may exclude authorization for any online transaction exceeding a predetermined monetary amount, e.g., $100. In another example, a person may require different types of challenges for different transactions. Thus, for example, a user may configure the profile to require only a personal identification number (PIN) for in-person purchases up to $100; a PIN and personal knowledge challenge for purchases between $100 and $500; and PIN, personal knowledge challenge and biometric verification for purchases over $500. In the case of on-line purchases, for example, the user configure a profile to require geo-location verification to coincide with one more predetermined locations for example, the user's work and home locations. Due to space considerations on device 200, personal knowledge questions may be binary or multiple-choice questions (e.g., yes/no or a/b/c/d) or numerical. The user may pre-configure the challenge questions in advance of the transaction.

Third party or user may also configure adaptable levels of security during the transaction. Thus, for example, if the biometric read is less than fully satisfactory, but not clearly belonging to a different person, the third party may request further authentication from user using another input on device 200. The amount of verification required may depend, for example, on the nature and/or amount of the transaction or on a preconfigured profile of user.

In some embodiments, the trusted authority may detect that the user is under duress based on input data, for example, based on voice imprint or predetermined false responses to personal question challenge. In such case, the trusted authority may record the exact time and location of the user, for example, using the geo-location sensor on the device and alert local authorities, while allowing the transaction to go through by registering the authentication attempt as positive.

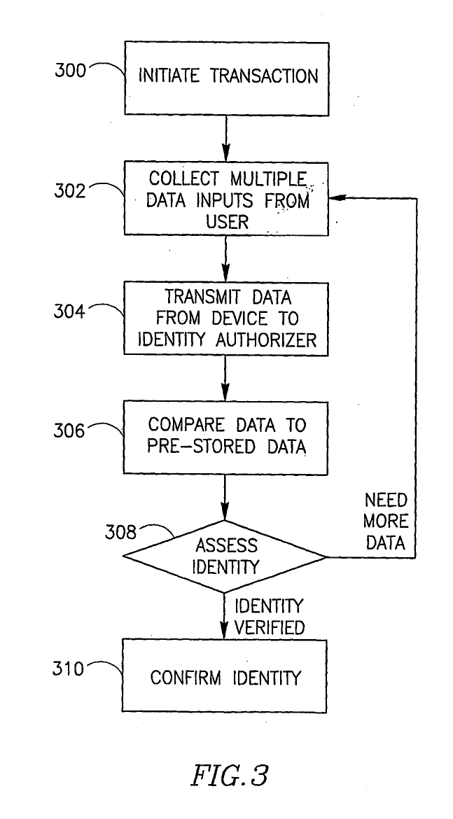

Reference is made to FIG. 3, a flow diagram of a method in accordance with embodiments of the invention. A transaction is initiated at block 300, for example, by a user engaging a merchant physically or on-line. If a trusted authority is used, the user or the merchant may send a communication to trusted authority to initiate the process.

In some embodiments, and in block 302, a portable device may collect multiple data inputs from a user of such device, and such multiple data inputs may include for example location data of the device, biometric data of the user, a response to at least one inquiry made to the user on for example the device, or other data. In some embodiments the collected data may be incorporated into or used in the calculation of for example an electronic key.

In block 304, data may be transmitted from the device to a party, such as a third party, such third party being one who is not a party to a particular transaction, or who is not the party that requested the particular identity authorization. In some embodiments, collected data may be transmitted from the device to the third party over a wireless link.

In some embodiments, a user of a device may transmit directly to a second party such as for example a merchant, an initial identification code or other data. Such initial data may be transferred by the second party or merchant to for example the third party, and the third party may accept such initial data as a signal to initiate an identification confirmation of a user.

In block 306, the third party may compare data transmitted by the device to pre-stored data that may be correlated to the user of the device.

In block 308, the third party may assess the collected data to determine if there is sufficient data to confirm an identity of for example a user. For example, in some embodiments an amount or type of data that may be required to confirm an identity of for example a user may vary depending on for example the kind of transaction or action that is being requested by a user. For example, if a transaction involving a large monetary sum is requested, several data inputs may be required to match a user's pre-stored data. A transaction involving a relatively small sum may or low security level may require less data to confirm an identity.

In block 310 the third party may confirm an identity of the user of the device to a second party, such as for example a merchant or some other party to a transaction who may have requested the identity confirmation.

In some embodiments, a time between when a query is posed to a user over a device, and when such query is answered may be measured. In some embodiments, if such measured time is in excess of a pre-defined threshold, such delay may be deemed an indication that the user of the device cannot be confirmed. In some embodiments a first, second and third parties may for example synchronize their clocks such as for example clock or timing devices in one or more devices; a user may receives one or more challenges from for example a third party and the third party may times the user's responses. The user's device may transmit the responses and their respective response times back to a third party for evaluation. In some embodiments, no such synchronization may be perfomied.

In some embodiments, a user of a device may transmit to a second party such as for example a merchant, an initial identification code or other data Such initial data may be transferred by the second party or merchant to for example the third party, and the third party may accept such initial data as a signal to initiate an identification confirmation of a user.

While the invention has been described with respect to a limited number of embodiments, it will be appreciated that may variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes fall within the true spirit of the invention.

What is claimed is:

1. A method comprising:
requesting verification for a transaction;
receiving at a portable device requests for data input, including biometric data of a user, a geospatial position of said device, a query posed to said user using said device, and an identification data from a memory associated with said device;
obtaining responses to said requests for data input; and
transmitting responses to said requests for data input.

2. The method as in claim 1, further comprising generating an electronic key using parameters from said responses to said requests for data inputs, wherein said transmitting responses comprises transmitting said key over a wireless transmitter.

3. The method as in claim 1, wherein said biometric data of a user is selected from the group consisting of a fingerprint of said user, a voice print of said user, an eye scan of said user, and a vein scan of said user.

4. The method as in claim 1, wherein said data inputs are transmitted wirelessly.

5. The method as in claim 1, comprising measuring a time between the step of receiving said query and said step of obtaining the response to said query.

6. The method as in claim 5, further comprising receiving notification of rejection of said transaction if said measured time is above a predetermined limit.

7. The method as in claim 1, comprising receiving a notification of an acceptance or rejection of said transaction.

8. A method for verifying a contemplated transaction between a first party and a second party comprising:
receiving at a central device a request for transaction verification;
receiving from a portable device biometric data of a user, a geospatial position of said portable device, and at least one identification data;
processing said biometric data, said geospatial position, said at least identification data to determine whether transaction verification should be provided; and
transmitting a result of said processing to a merchant device.

9. The system of claim 8, further comprising:
transmitting to said portable device at least one query for personalized information pertaining to said user;
receiving at least one response to said at least one query; and
comparing said at least one response to at least one predetermined response to said at least one query, wherein said processing step further includes processing a result of said comparing step.

10. The system of claim 8, wherein said biometric data includes voice data, and further comprising processing said voice data to determine whether said user is under duress.

11. A mobile device comprising:
a location sensor to detect location data of said device;
a biometric sensor to detect a biometric property of a user of said device;
a display to prompt said user for personalized manual input;
a memory to store identification data;
a user input interface to receive said personalized manual input from said user;
a transmitter to wirelessly transmit said location data, said biometric data, said personalized input and said identification data; and
a mobile power source to power said device.

12. The device as in claim 11, further comprising a processor to encrypt at least one data selected from the group consisting of said location data, said identification data, said biometric data and said personalized manual input, wherein said transmitter is to transmit said encrypted data.

13. The device as in claim 11, wherein said a biometric sensor comprises at least one device selected from the group consisting of a fingerprint sensor, a microphone, a voice scanner, an eye scanner, and a blood vessel scanner.

14. The device as in claim 11, comprising a receiver to receive wireless signals from another biometric sensor.

15. The device as in claim 11, wherein said device has height dimension of less than 3.6 inches, width dimension of less than 2.6 inches and thickness of less than 0.50 inches.

16. A system for verifying a contemplated transaction between a first party and a second party comprising:
a first device including a user input interface, a biometric sensor, a location sensor, a memory, a display and a transmitter to transmit data from said interface, said biometric sensor, said location sensor and said memory; and
a second device including a receiver to receive data from said first device, a processor to process said received data and further to determine whether the contemplated transaction should be verified, and a transmitter to transmit said determination; and
a third device including a transmitter to transmit to said second device a request for verification and a receiver to receive from said second device said determination.

17. The system of claim 16,
wherein said transmitter of said second device is further to transmit a query for personalized information to said first device,
wherein said display of said first device is farther to display said query for personalized information, said input interface of said first device is to receive responsive input from said first party responsive to said query and said transmitter is to transmit to said second device said responsive input, and
wherein said processor of said second device is further to process said responsive input in said determination whether the contemplated transaction should be verified.

18. The system as in claim 16, wherein said first device further comprises a portable power source.

19. The system as in claim 16, wherein said first device further comprises a processor to encrypt data from said interface, said biometric sensor, said location sensor and said memory, and wherein said transmitter of said first device is further to transmit said encrypted data.
